(19) United States
(12) Patent Application Publication
(10) Pub. No.: US 2026/0162451 A1
(43) Pub. Date: Jun. 11, 2026

(54) SYSTEM AND METHOD FOR DETECTING ZERO-SHOT IDENTITY DISINFORMATION USING MULTIMODAL INTERACTION IN VIDEO

(71) Applicant: GACHON UNIVERSITY OF INDUSTRY-ACADEMIC COOPERATION FOUNDATION, Seongnam-si (KR)

(72) Inventors: Chang CHOI, Seoul (KR); JunHo YOON, Seoul (KR)

(73) Assignee: GACHON UNIVERSITY OF INDUSTRY-ACADEMIC COOPERATION FOUNDATION, Seongnam-si (KR)

(21) Appl. No.: 19/179,785

(22) Filed: Apr. 15, 2025

(30) Foreign Application Priority Data
Sep. 2, 2024 (KR) 10-2024-0118292

(51) Int. Cl. G06V 20/00; G06F 21/64; G06V 10/764; G06V 10/774; G06V 20/40; G06V 40/10; G10L 17/02; G10L 17/04; G10L 17/10

(52) U.S. Cl. CPC G06V 20/95; G06F 21/64; G06V 10/764; G06V 10/774; G06V 20/46; G06V 40/10; G10L 17/02; G10L 17/04; G10L 17/10

(57) ABSTRACT

The present disclosure relates to a system and method for detecting zero-shot identity disinformation using multimodal interaction in video. More specifically, the present disclosure pertains to a system and method that detects identity disinformation (DeepFake), including zero-shot identity disinformation in the video, by training the interactions between different modalities through co-learning of visual information, auditory information, and linguistic information in video composed of multiple different modalities.

### CROSS REFERENCE TO RELATED APPLICATION

This application claims priority to Korea Patent Application No. 10-2024-0118292 filed on Sep. 2, 2024, the content of which is expressly incorporated by reference in its entirety.

### TECHNICAL FIELD

The present disclosure relates to a system and method for detecting zero-shot identity disinformation using multimodal interaction in video. More specifically, the present disclosure pertains to a system and method that detects identity disinformation (DeepFake), including zero-shot identity disinformation in the video, by training the interactions between different modalities through co-learning of visual information, auditory information, and linguistic information in video composed of multiple different modalities.

Acknowledgement: The present invention was supported by the Culture, Sports and Tourism R&D Program through the Korea Creative Content Agency grant funded by the Ministry of Culture, Sports and Tourism in 2023 (Project Name: Cultural Technology Specialist Training and Project for Metaverse Game, Project Number: RS-2023-00227648).

### BACKGROUND

With the recent advancements in generative AI technology, DeepFake—fake data that appears even more realistic than real data in various fields such as data augmentation—is being created and misused and thus leading to widespread proliferation of damage.

DeepFake, a blending word of deep learning and fake, refers to fake contents (videos) that are difficult to distinguish from reality, created by manipulating a face, voice, or photos in video using artificial intelligence technology. That is, a deepfake is a form of media manipulation in which an individual's identity in video is altered-such as by replacing their face, voice, or image with those of another person-resulting in entirely new actions or speech.

Such deepfake has the advantage of being used creatively in films, games, and art, however, at the same time, deepfake can be misused for malicious purposes such as spreading fake news, disinformation, defamation, and fraud, and so there are growing social concerns.

To address these issues, multimodal AI that considers various modalities for classifying targets is being developed and commercialized.

Multimodal AI is a technology that simultaneously trains various modalities within video, and the effectiveness of the technology has been demonstrated in various fields, including autonomous driving, biometric recognition, and medical image analysis.

Furthermore, multimodal AI can be used for effectively detecting deepfake in single and multiple modalities by analyzing all the information involved in the deepfake.

Traditional multimodal AI includes the Score-Level Fusion (SF), which combines data from different modalities, and the Feature-Level Fusion (FF) method, which combines embedding vectors (feature vectors) to integrate data from various modalities.

The Score-Level Fusion method involves the use of individual AI models for each modality to extract (predict) probability values (scores) for the labels and then fuses them, and the Feature-Level Fusion method is a technology that fuses embedding vectors (feature vectors) for the data from each modality.

The traditional multimodal AI individually trains data from different modalities and then fuses the results, so the overall performance depends on the recognition performance of every single modality data. Thus, there is a constraint that the data from different modalities must be mutually matched in the traditional multimodal AI, and there is a drawback in that all the information from each modality cannot be considered interactively.

To address these issues, research on multimodal AIs using transformers considering information across different modalities is recently ongoing.

However, the multimodal AIs using transformers address limitations requiring sufficient training data owing to the lack of inductive bias.

Thus, existing research on multimodal AI-based deepfake detection has limitations in detecting (sensing) deepfake (i.e., disinformation) from zero-shot identities.

Accordingly, the present invention presents a method to accurately detect disinformation (i.e., deepfake) in identities, including zero-shot identities within video, by training the interactions between different modalities through co-learning of data from the different modalities, such as visual information, auditory information, and linguistic information in the video.

In other words, the present invention pertains to accurately detect disinformation in identities, by training the interactions among the visual information, auditory information, and linguistic information through the reconstruction of the visual information by using auditory information and linguistic information from other modalities.

Next, a brief explanation of the prior art in the technical field of the present invention will be provided, followed by a description of the technical aspects that the present invention aims to achieve in comparison to the prior art.

First, Korean Patent Registration No. 2523372 (Apr. 20, 2023) relates to a method and apparatus for real-time deepfake detection, in which whether an input video corresponds to a deepfake based on the similarity of features extracted from the corneal posterior scattering images is determined by detecting corneal posterior scattering images from two eye regions detected from a single face in the input video.

In other words, Korean Patent Registration No. 2523372 only discloses determining the deepfake status based solely on the features of the corneal posterior scattering images.

On the other hand, the present invention aims to detect disinformation in identities within video by utilizing the interactions among visual information, auditory information, and linguistic information, which are composed of data from different modalities. However, Korean Patent Registration No. 2523372 does not disclose, suggest, or imply any of these technical features of the present invention.

Additionally, Korean Patent Publication No. 2024-0080755 (Jun. 7, 2024) relates to a method and apparatus for detecting illegal advertisements using multimodal learning, in which illegal advertisements are detected by determining the similarity between the original advertisement content and the target advertisement content based on the distance by mapping the multimodal joint representation method to a single data space through a trained model, after separating images and text in advertisement content, and then determining the degree of similarity to the original advertisement content from the perspective of images and text using a separately trained similarity determination unit.

In other words, Korean Patent Publication No. 2024-0080755 is configured to determine the legality of the target advertisement by calculating the similarity between the target and original advertisements, and this prior art is not aimed at detecting disinformation in identities of individuals within video.

On the other hand, the present invention is configured to extract visual information, auditory information, and linguistic information from video and detect disinformation in identity within the video through the interactions between these modalities. Therefore, technical configurations, objectives, and effects of the present invention are significantly different from those of the prior arts.

### BRIEF SUMMARY OF THE EMBODIMENTS

The present disclosure is invented to solve the above-mentioned problems, and it is the objective of the present invention to provide a method and system for detecting zero-shot identity disinformation by using multimodal interactions in video, in which the identity disinformation including zero-shot identities within the video is detected (sensed) by utilizing interactions among these different modalities through the co-learning of visual information, auditory information, and linguistic information, which are composed of different modalities within the video.

Furthermore, it is another objective of the present invention to provide a system and a method extracting visual information with the mid frame of the video, auditory information by transforming a 1-D waveform representing the amplitude over time in the video to a 2-D MFCC (Mel Frequency Cepstral Coefficient), and linguistic information in the video with data indicating a predetermined high level threshold of confidence through measuring the similarity score.

Furthermore, it is another objective of the present invention to provide a system and method for extracting visual information feature and class (label) tokens, converting the feature and tokens into multimodal class tokens, and converting the class tokens into multimodal distillation tokens.

Furthermore, it is another objective of the present invention to provide a system and method for extracting a global context through interactions among different modalities by reconstructing the multimodal class token and multimodal distillation token of visual information features with auditory information and linguistic information.

Furthermore, it is another objective of the present invention to provide a system and method for detecting identity disinformation within video by utilizing interactions among different modalities.

A system for detecting zero-shot identity disinformation using multimodal interaction in video according to an embodiment of the present invention, comprises: a visual information extractor configured to extract visual information from the video; an auditory information extractor configured to extract auditory information corresponding to the visual information extracted from the video; a linguistic information extractor configured to extract linguistic information corresponding to the auditory information extracted from the video; a visual information feature extractor configured to extract visual information feature using the extracted visual information; a first multimodal token extractor configured to extract a first multimodal class token and a first multimodal distillation token of the video according to interaction between the visual information and the auditory information by applying the extracted visual information feature and the extracted auditory information to a first co-learning model; a second multimodal token extractor configured to extract a second multimodal class token and a second multimodal distillation token of the video according to interaction between the visual information and the linguistic information by applying the extracted visual information feature and the extracted linguistic information to a second co-learning model; and an identity disinformation detector configured to detect identity disinformation for the video by fusing the extracted first multimodal class token, the extracted first multimodal distillation token, the extracted second multimodal class token, and the extracted second multimodal distillation token, wherein the first co-learning model is configured to be generated by training the interaction between visual information and auditory information by performing co-learning of visual information feature and auditory information of training video, and the second co-learning model is configured to be generated by training the interaction between visual information and linguistic information by performing co-learning of visual information feature and linguistic information of the training video.

The visual information extractor is further configured to extract the visual information by extracting mid frame from entire frames of the video; the auditory information extractor is further configured to extract the auditory information by transforming a waveform corresponding to the visual information into 2-dimensional MFCC (Mel Frequency Cepstral Coefficient); and the linguistic information extractor is further configured to extract the linguistic information by extracting texts corresponding to the visual information and transforming each of words composing the texts into a word token.

The visual information feature extractor is further configured to construct a visual information embedding input sequence by dividing the extracted visual information into a plurality of patches and embedding the dividend plurality of patches and positional information for each of the plurality of patches for the visual information, and extract the visual information feature including multimodal class token and multimodal distillation token for the visual information by applying the constructed visual information embedding input sequence into a visual information feature extraction model.

The visual information feature extraction model is configured to be generated by training a visual information embedding input sequence for training, which embeds multimodal class token for the visual information extracted from each of a plurality of training videos, a plurality of patches for the visual information, and positional information for each of the plurality of patches, output multimodal class token and multimodal distillation token indicating class for the visual information, when a visual information embedding input sequence for a real video is input, and output feature tokens for each of the plurality of patches of the inputted a visual information embedding input sequence, and output the multimodal class token by concatenating the feature tokens.

The first multimodal token extractor is further configured to construct a first multimodal input sequence by dividing the extracted auditory information into a plurality of patches, and embedding each of the plurality of the patches, positional information of each of the plurality of the patches, and the extracted visual information feature, and extract the first multimodal class token and the first multimodal distillation token by applying the constructed first multimodal input sequence to the first co-learning model, wherein the first co-learning model is configured to be generated by training interaction between visual information and auditory information by cooperatively training visual information and auditory information of the video through each of the first multimodal input sequences constructed for each of the plurality of training videos.

The second multimodal token extractor is further configured to construct a second multimodal input sequence by embedding a word token for each word composed of the extracted linguistic information, positional information of each word token, and the extracted visual information feature, and extract the second multimodal class token and the second multimodal distillation token by applying the constructed second multimodal input sequence to the second co-learning model, wherein the second co-learning model is configured to be generated by training interaction between visual information and linguistic information by cooperatively training visual information and linguistic information of the video through each of the second multimodal input sequences constructed for each of the plurality of training videos.

The identity disinformation detector is further configured to detect the identity disinformation by fusing the extracted first multimodal class token, the extracted first multimodal distillation token, the extracted second multimodal class token, and the extracted second multimodal distillation token, and whether the video contains identity disinformation.

Moreover, a method for detecting zero-shot identity disinformation using multimodal interaction in video according to another embodiment of the present invention comprises: extracting visual information from the video; extracting auditory information corresponding to the visual information extracted from the video; extracting linguistic information corresponding to the auditory information extracted from the video; extracting visual information feature using the extracted visual information; extracting a first multimodal class token and a first multimodal distillation token of the video according to interaction between the visual information and the auditory information by applying the extracted visual information feature and the extracted auditory information to a first co-learning model; extracting a second multimodal class token and a second multimodal distillation token of the video according to interaction between the visual information and the linguistic information by applying the extracted visual information feature and the extracted linguistic information to a second co-learning model; and detecting identity disinformation for the video by fusing the extracted first multimodal class token, the extracted first multimodal distillation token, the extracted second multimodal class token, and the extracted second multimodal distillation token, wherein the first co-learning model is configured to be generated by training the interaction between visual information and auditory information by performing co-learning of visual information feature and auditory information of training video, and the second co-learning model is configured to be generated by training the interaction between visual information and linguistic information by performing co-learning of visual information feature and linguistic information of the training video.

The extracting of the visual information feature further comprises: constructing a visual information embedding input sequence by dividing the extracted visual information into a plurality of patches and embedding the dividend plurality of patches and positional information for each of the plurality of patches for the visual information, and extracting the visual information feature including multimodal class token and multimodal distillation token for the visual information by applying the constructed visual information embedding input sequence into a visual information feature extraction model.

The extracting of the first multimodal token further comprises: constructing a first multimodal input sequence by dividing the extracted auditory information into a plurality of patches, and embedding each of the plurality of the patches, positional information of each of the plurality of the patches, and the extracted visual information feature, and extracting the first multimodal class token and the first multimodal distillation token by applying the constructed first multimodal input sequence to the first co-learning model; the extracting of the second multimodal token further comprises: constructing a second multimodal input sequence by embedding a word token for each word composed of the extracted linguistic information, positional information of each word token, and the extracted visual information feature, and extracting the second multimodal class token and the second multimodal distillation token by applying the constructed second multimodal input sequence to the second co-learning model; and the detecting of identity disinformation comprises: detecting the identity disinformation by classifying whether the video contains identity disinformation by fusing the extracted first multimodal class token, the extracted first multimodal distillation token, the extracted second multimodal class token, and the extracted second multimodal distillation token.

As described above, the system and method for detecting zero-shot identity disinformation using multimodal interaction in video are effective to accurately detect whether the video contains identity disinformation by training the interaction between different modalities through co-learning of visual information, auditory information, and linguistic information of the video.

Additionally, the present invention is effective to detect illicit activities across multiple domains such as detection of identity disinformation in video, identification of illegal content (e.g., advertisement), etc. by learning the interaction between different modalities.

### BRIEF DESCRIPTION OF THE DRAWINGS

FIG. 1 is a diagram illustrating a method and system for detecting zero-shot identity disinformation using multimodal interaction in video according to an embodiment of the present invention.

FIG. 2 is a diagram illustrating a method for performing co-learning according to an embodiment of the present invention.

FIG. 3 is a diagram illustrating a visual information feature extraction model according to an embodiment of the present invention.

FIG. 4 is a diagram illustrating a first and second co-learning model according to an embodiment of the present invention.

FIG. 5 is a diagram illustrating a method for detecting identity disinformation according to an embodiment of the present invention.

FIG. 6 is a block diagram illustrating a system for detecting zero-shot identity disinformation using multimodal interaction in video according to an embodiment of the present invention.

FIG. 7 is a diagram illustrating performance comparison between prior arts and the present invention through accuracy according to an embodiment of the present invention.

FIG. 8 is a diagram illustrating performance comparison between prior arts and the present invention through F1-Score according to an embodiment of the present invention.

FIG. 9 is a flow chart illustrating procedures for detecting zero-shot identity disinformation using multimodal interaction in video according to an embodiment of the present invention.

### DETAILED DESCRIPTION OF THE EXEMPLARY EMBODIMENTS

Hereinafter, preferred embodiments of the present invention entitled as a method and system for detecting zero-shot identity disinformation using multimodal interaction in video will be described in detail with reference to the accompanying drawings. Identical reference numerals in the drawings indicate the same components. In addition, the specific structural or functional descriptions of the embodiments of the present invention are provided for the purpose of illustrating the embodiments of the present invention, and unless otherwise defined, all terms used herein, including technical or scientific terms, shall have the meanings generally understood by those skilled in the art to which the present invention pertains. Terms that are commonly used and defined in dictionaries should be interpreted in accordance with their meanings in the context of the relevant technology, and unless explicitly defined in this specification, should not be interpreted in an idealized or excessively formal manner.

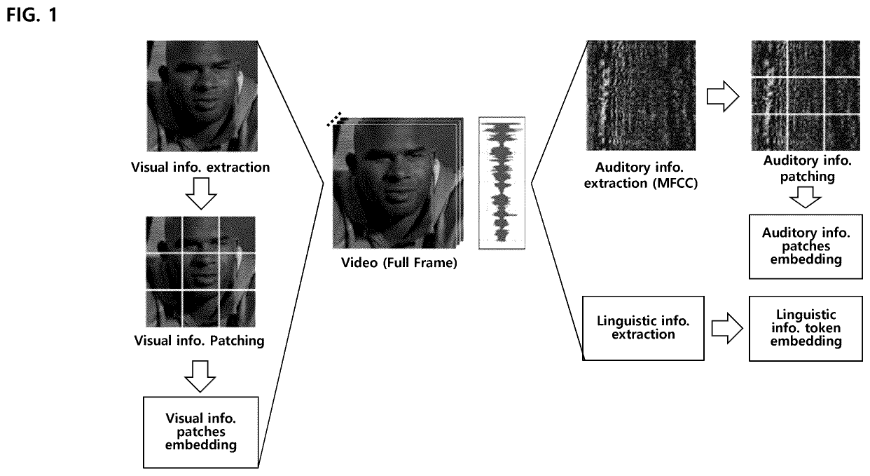

FIG. 1 is a diagram illustrating a method and system for detecting zero-shot identity disinformation using multimodal interaction in video according to an embodiment of the present invention.

As shown in FIG. 1, system for detecting zero-shot identity disinformation using multimodal interaction in video (hereafter refers to a identity disinformation detection system) 100 according to an embodiment of the present invention is configured to extract visual information, auditory information, and linguistic information, which are different modalities, from input video, input the extracted visual information, auditory information, and linguistic information into an identity disinformation detection model of the present invention, and detect disinformation (i.e., deepfake) for identity in the video including zero-shot identity by using the interaction (i.e., multimodal interaction) among the visual information, auditory information, and linguistic information.

The identity disinformation detection model is generated for detecting whether disinformation is contained for an identity in the video, by learning the interaction among visual information, auditory information and linguistic information.

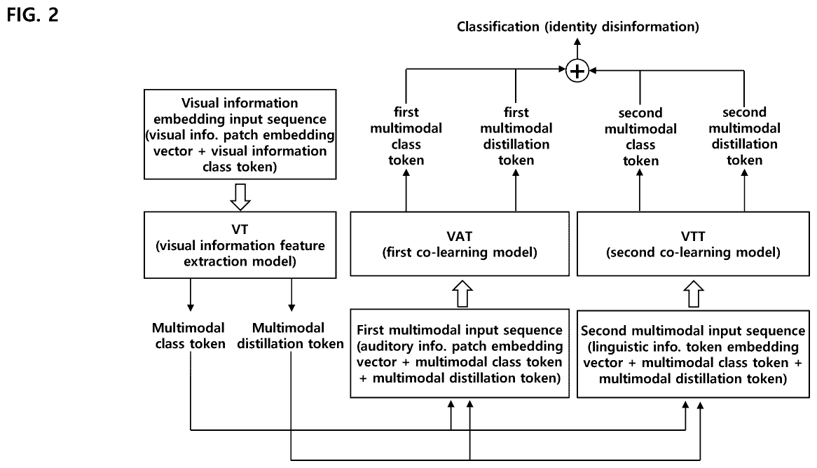

The identity disinformation detection model is explained by referring to FIG. 2 to FIG. 4, in detail.

To do this, the identity disinformation detection system 100 is configured to extract visual, audio, and text(linguistic) information from videos.

To extract visual information while considering the continuity of the video, the identity disinformation detection system 100 is configured to extract visual information from a mid frame that preserves temporal feature of an object by analyzing the previous and subsequent frames in the entire video frames.

In this case, the identity disinformation detection system 100 can extract a frame (n/2) located in the middle of the entire video frames (n frames) sequence as visual information.

The auditory information is extracted from a sound (e.g., voice of identity) from the video, and transformed from a 1-D waveform representing the amplitude over time for the sound to a 2-D MFCC (Mel Frequency Cepstral Coefficient) representation that reflects domain or environment condition invariant frequency information for generalization.

The auditory information is extracted from the sound (voice) that is temporally continuous based on visual information.

The identity disinformation detection system 100 is configured to extract linguistic information for visual information through a specific API. The linguistic information refers to texts (Ex., captions) for the auditory information.

The identity disinformation detection system 100 can be configured to extract texts by using the Google STT (Speech-to-Text) API.

In addition, the identity disinformation detection system 100 is configured to calculate similarity score between the extracted each text and the extracted each auditory information, and the text with a similarity of 0.9 or higher is used (extracted) as linguistic information.

Moreover, to construct input of the identity disinformation detection model, the identity disinformation detection system 100 is configured to divide the extracted visual and auditory information into a plurality of patches. There can be 256 patches in the form of 16×16.

The identity disinformation detection system 100 is configured to embed (i.e., vectorizing) each of the plurality of patches for visual information and position information for each of the plurality of patches for the visual information and utilize the embedded vectors as inputs for the identity disinformation detection model.

Furthermore, the identity disinformation detection system 100 is configured to convert each of the words constituting linguistic information into word tokens, embed (i.e., vectorizing) each of the converted word tokens and position information of each of the word tokens, and utilize the embedded vectors as inputs for the identity disinformation detection model.

The conversion into a word token refers to indexing or encoding each word in a way that allows the identity disinformation detection model to comprehend the meaning of each word.

FIG. 2 is a diagram illustrating a method for performing co-learning according to an embodiment of the present invention.

As shown in FIG. 2, a method for co-learning visual information, auditory information and linguistic information composed of different modalities according to an embodiment of the present invention is performed based on a plurality of training data comprising visual information, auditory information and linguistic information, which are extracted from a plurality of training videos including normal videos, and videos including identity disinformation (deepfake videos).

The co-learning according to the present invention is configured to include a visual information feature extraction model, a first co-learning model, and a second co-learning model.

In addition, the co-learning according to the present invention is configured to include a visual information feature extraction model, a first co-learning model, a second co-learning model, or the combinations thereof.

The visual information feature extraction model is generated by training a class token that is extracted from a plurality of learning data for visual information, each of the plurality of patches for each of the visual information, and position information for each of the plurality of patches.

The visual information feature extraction model is configured to output a multimodal class token and a multimodal distillation token for the visual information, when a visual information embedding input sequence which embeds each of the plurality of patches for the visual information extracted from input videos, position information for each of the plurality of patches for the visual information.

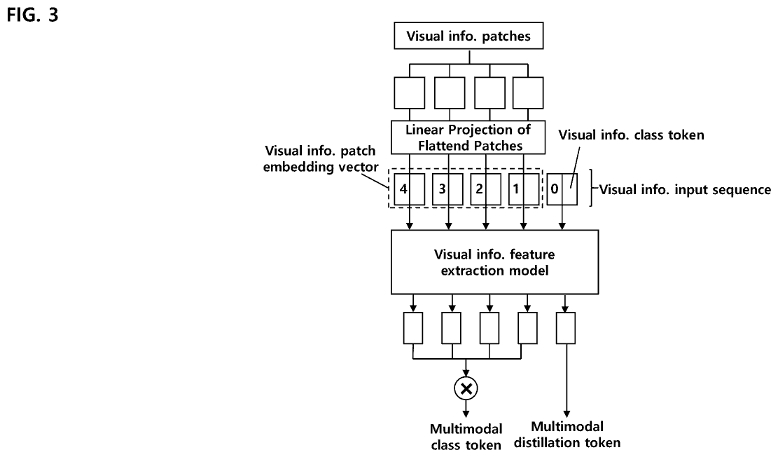

The structure of the visual information feature extraction model is explained in detail by referring to FIG. 3.

The first co-learning model is generated by co-learning a multimodal class token extracted from the visual information feature extraction model, a visual information feature including a multimodal distillation token, and auditory information extracted from corresponding learning data.

The first co-learning model is configured to output a first multimodal class token and a first multimodal distillation token for corresponding videos, when the first multimodal input sequence which embed visual information including multimodal class token and multimodal distillation token, each a plurality of patches which are dividend from the corresponding videos, and position information for each of the plurality of patches are inputted.

The second co-learning model is generated by co-learning multimodal class token and multimodal distillation token extracted from visual information feature extraction model, and linguistic information extracted from corresponding training data.

The second co-learning model is configured to output the second multimodal class token and the second multimodal distillation token for corresponding videos, when the second multimodal input sequence is inputted. Wherein the second multimodal input sequence embeds visual information feature including multimodal class token and multimodal distillation token, word token for each of words comprised of linguistic information extracted from corresponding videos, and position information of each of the word tokens.

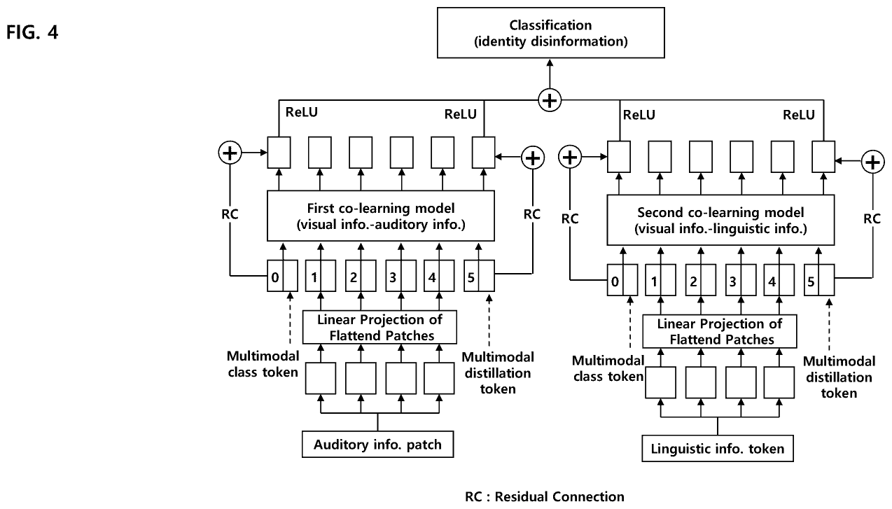

The first and second co-learning models are explained in more detail by referring to FIG. 4.

That is, the first co-learning model is generated by co-learning visual information and auditory information, and the second co-learning model is generated by co-learning visual information and linguistic information.

Therefore, the identity disinformation detection model of the present invention is generated by learning the interactions among visual information, auditory information, and linguistic information through jointly learning visual information, auditory information, and linguistic information.

FIG. 3 is a diagram illustrating a visual information feature extraction model according to an embodiment of the present invention.

As shown in FIG. 3, the visual information feature extraction model according to one embodiment of the present invention, is generated by training a visual information embedding input sequence, which is configured for training to embed a class token for the visual information (i.e., a visual information class token), a plurality of patches for the visual information, and the positional information for each of the plurality of patches through a VT (Vision Transformer).

The visual information class token means the label for the visual information (i.e., whether the visual information is identity disinformation or not, or whether the visual information is deepfake or not).

During training, the visual information embedding input sequence for training is constructed by embedding visual information class token for visual information extracted from training video, a plurality of patches for visual information, and the positional information for each of the plurality of patches in the visual information. Wherein the visual information class token is positioned at the very beginning of the visual information embedding input sequence for training.

That is, since the VT (Vision Transformer) takes a one-dimensional visual information embedding input sequence as input, two-dimensional data of visual information (i.e., frames) are divided into a plurality of patches, a visual information embedding input sequence embedding with a visual information class token for the visual information is then constructed and used to train the VT. Once the training is complete, the VT becomes the visual information feature extraction model.

The visual information embedding input sequence is constructed by flattening and linearly projecting multiple patches (i.e., Linear Projection of Flattened Patches) of the visual information, each of which is formed as a token for input into the VT (or the visual information feature extraction model).

The VT is configured to train the relationships between patches by applying a Multi-Head Attention algorithm, which enables the model to simultaneously or concurrently recognize the relationships among the patches of visual information.

The visual information feature extraction model is configured to output a feature token for each patch, concatenate the output feature tokens to produce a multimodal class token, which is represented by [Equation 1].

$$\begin{matrix}{M}_{class} = ( {V}_{L}^{1} , … , {V}_{L}^{N} ) \\ Wherein , {V}_{L}^{1} to {V}_{L}^{N}\end{matrix} \qquad [ Equation 1 ]$$

refer to the feature tokens corresponding to each patch of the visual information

In addition, the visual information feature extraction model is configured to output a visual class token, which corresponds to the label of the visual information, as a multimodal distillation token represented by [Equation 2].

$$\begin{matrix}{M}_{distillation} = {V}_{L}^{0} \\ Wherein , {V}_{L}^{0}\end{matrix} \qquad [ Equation 2 ]$$

refers to a feature token for a visual information class token.

That is, the identity disinformation detection system 100 is configured to extract visual information feature by concatenating the feature tokens for each patch of the visual information, which outputs through the visual feature extraction model, and setting the concatenated feature tokens as a multimodal class token, and by setting the class token for the visual information as a multimodal distillation token.

The extracted multimodal class token and multimodal distillation token are used in co-learning to generate the first co-learning model and the second co-learning model.

The identity disinformation detection system 100, upon receiving an actual video from outside, is configured to construct a visual information embedding input sequence by extracting visual information, auditory information, and linguistic information from the video, dividing the extracted visual information into a plurality of patches, and embedding the plurality of patches and positional information for each of the plurality of patches, and input the visual information embedding input sequence to a visual information feature extraction model, and thereby extract a visual information feature including a multimodal class token and multimodal distillation token.

Since the visual information feature extraction model already completes training at this point, the visual information embedding input sequence does not include a class token of the visual information.

FIG. 4 is a diagram illustrating a first and second co-learning model according to an embodiment of the present invention.

As shown in FIG. 4, the first co-learning model according to one embodiment of the present invention, is generated by training a first multimodal input sequence for training through VAT (Vision-Audio Transformer).

The first multimodal input sequence for training is configured to construct, as shown in [Equation 3], by embedding a multimodal class token and a multimodal distillation token derived from the visual information of a training video extracted through a visual information feature extraction model, a plurality of patches obtained by segmenting the extracted auditory information, and positional information corresponding to each of the patches.

The auditory information is extracted from the sound (voice) that is temporally continuous based on visual information.

$${VA}_{0} = [ {M}_{c l a s s} ; {A}_{L}^{1} ; … ; {A}_{L}^{N} ; {M}_{distill} ] + {E}_{p o s} \qquad [ Equation 3 ]$$

Wherein, M_{class} a multimodal class token extracted through the visual information feature extraction model, distill is a multimodal distillation token extracted through a visual information feature extraction model,

$${A}_{L}^{1} to {A}_{L}^{N}$$

refer to each patch for the auditory information, and Eₚₒₛ refers to positional information for the multimodal class token, each patch of the auditory information, and the multimodal distillation token.

In other words, the VAT is configured to train the interaction between visual information and auditory information, by jointly training the visual visual information and auditory information through a plurality of the first multimodal input sequences according to a plurality of training data.

The VAT is configured, same as the VT to which a multi-head attention algorithm is applied, to train the relationships between the multimodal class token and the multimodal distillation token, and those between the patches of the auditory information.

In addition, the VAT is configured to finally output the first multimodal class token and the first multimodal distillation token of the corresponding video, which are representation vectors for the video.

In addition, the second co-learning model is generated by training the second multimodal input sequence through VTT (Vision-Text Transformer).

The second multimodal input sequence for training is, as shown in [Equation 4], composed by embedding a multimodal class token and a multimodal distillation token for the visual information of the training video extracted through a visual feature extraction model, each word token for each word that constitutes the extracted linguistic information, and positional information corresponding to each word token.

The linguistic information refers to texts (Ex., captions) for the auditory information, which is extracted from the visual information.

$$V {T}_{0} = [ {M}_{c l a s s} ; {T}_{L}^{1} ; … ; {T}_{L}^{N} ; {M}_{distill} ] + {E}_{p o s} \qquad [ Equation 4 ]$$

Wherein, M_{class} a multimodal class token extracted through the visual information feature extraction model, M_{distill} is a multimodal distillation token extracted through a visual information feature extraction model,

$${T}_{L}^{1} to {T}_{L}^{N}$$

refers to each word token for the linguistic information, and Eₚₒₛ refers to positional information for the multimodal class token, each word token of the linguistic information, and the multimodal distillation token.

In other words, the VAT is configured to learn the interaction between visual information and auditory information by jointly training the visual information and auditory information through a plurality of second multimodal input sequences corresponding to a plurality of training data.

The VTT is configured, same as the VT to which a multi-head attention algorithm is applied, to train the relationships between the multimodal class token and the multimodal distillation token, and the auditory information.

That is, both the VAT and VTT are configured to train of the interactions between different modalities by extracting global context from the first multimodal input sequence and the second multimodal input sequence through the multi-head attention mechanism.

Since the first co-learning model and the second co-learning model of the present invention are configured to extract global context, the zero-shot identity disinformation can be effectively detected through the fusion of the different modalities.

Additionally, the VTT is configured to finally output the second multimodal class token and the second multimodal distillation token of a corresponding video, which are representation vectors of the video.

The VAT and VTT, once training is completed, become the first co-learning model and the second co-learning model, respectively.

As described above, the first co-learning model and the second co-learning model are configured to perform co-learning of visual information and auditory information, and visual information and linguistic information, respectively. Therefore, no further additional mapping of information (data) between different modalities is required, and the issue of data imbalance can be resolved. Accordingly, this finally enables the first co-learning model and the second co-learning model to estimate and output the class token and the distillation token as the representation vectors of the video.

In addition, during the co-learning process, the identity disinformation detection system 100 is configured to classify a final output video into whether the identity disinformation is present or not, by outputting a probability value for whether the identity disinformation is present in the final output video by the fusion of the first multimodal class token, the first multimodal distillation token, the second multimodal class token, and the second multimodal distillation token. Wherein, if the probability value exceeds a predetermined threshold, the identity disinformation is detected in the final video. That is, the corresponding video is identified as a deepfake.

In addition, to prevent the loss of visual features during the interaction between visual information and auditory information, the identity disinformation detection system 100 is configured to output the first multimodal class token and the first multimodal distillation token according to [Equation 5], by concatenating a first residual connection (RC) between the input and output layers of the VAT, and applying ReLU (Rectified Linear Unit) function to the video.

$${VA}_{class} = R e L U ( {M}_{c ι a s s} + {VA}_{L}^{0} ) {VA}_{distillation} = R e L U ( {M}_{distillation} + {VA}_{L}^{n + 1} ) \qquad [ Equation 5 ]$$

Wherein, VA_{class} refers to a first multimodal class token of a video, M_{class} refers to a multimodal class token of visual information, and

$${VA}_{L}^{0}$$

refers to a multimodal class token of the video according to the visual information and the auditory information, which are outputs of VAT (the first co-learning model).

Moreover, VA_{distillation} refers to a first multimodal distillation token of the video, M_{distillation} refers to a multimodal distillation token for the visual information, and

$${VA}_{L}^{n + 1}$$

refers to a multimodal distillation token of the video for visual information and auditory information of the first co-learning model.

That is, the identity disinformation detection system (100) is configured to concatenate residual connections between the multimodal class token of the visual information and the multimodal class token derived from the interaction between visual information and auditory information which are outputs of the first co-learning model, concatenate residual connections between the multimodal distillation token of the visual information and the multimodal distillation token derived from the interaction between visual information and auditory information which are outputs of the first co-learning model, and finally extract the first multimodal class token and the first multimodal distillation token reflecting the interaction between visual and auditory information.

In addition, to prevent the loss of visual features during the interaction between visual information and textual information, the identity disinformation detection system 100 is configured to output the second multimodal class token and the second multimodal distillation token according to [Equation 6], by concatenating a second residual connection (RC) between the input and output layers of the VTT, and applying ReLU (Rectified Linear Unit) function to the video.

$${VT}_{class} = R e L U ( {M}_{c ι a s s} + {VT}_{L}^{0} ) {VT}_{distillation} = R e L U ( {M}_{distillation} + {VT}_{L}^{n + 1} ) \qquad [ Equation 6 ]$$

Wherein, VT_{class} refers to a second multimodal class token of a video, M_{class} refers to a multimodal class token for visual information, and

$${VT}_{L}^{0}$$

refers to a multimodal class token of the video according to visual information and linguistic information which are outputs of the VAT (the second co-learning model).

Furthermore, VT_{distillation} refers to a second multimodal class token of the video, M_{distillation} refers to a multimodal distillation token for the visual information, and

$${VT}_{L}^{n + 1}$$

refers to a multimodal distillation token of the video according to the interaction of visual information and linguistic information which are outputs of the second co-learning model.

That is, the identity disinformation detection system (100) is configured to concatenate residual connections between the multimodal class token of the visual information and the multimodal class token derived from the interaction between visual information and auditory information which are outputs of the second co-learning model, concatenate residual connections between the multimodal distillation token of the visual information and the multimodal distillation token derived from the interaction between visual information and auditory information which are outputs of the second co-learning model, and finally extract the second multimodal class token and the second multimodal distillation token reflecting the interaction between visual and auditory information.

The ReLU function is activated for preventing the loss of visual features, returns input value when it is positive, returns 0 when it is negative, thereby preventing the loss of visual features during the interaction between modalities.

In the late-level fusion stage, the identity disinformation detection system 100 is configured to detect whether the identity disinformation is present in the video, by fusing the first multimodal class token, the first multimodal distillation token, the second multimodal class token, and the second multimodal distillation token.

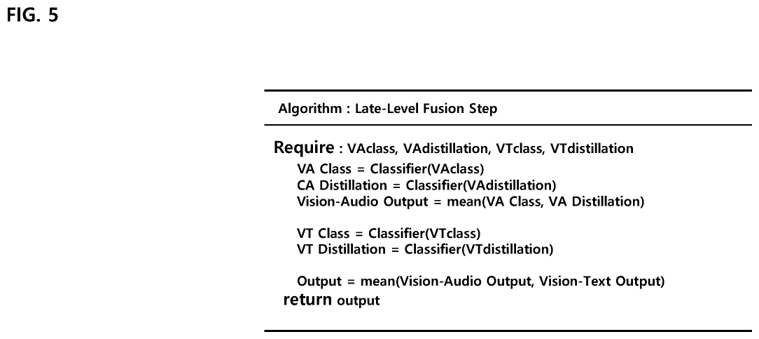

FIG. 5 is a diagram illustrating a method for detecting identity disinformation according to an embodiment of the present invention.

As shown in FIG. 5, a method for detecting identity disinformation according to an embodiment of the present invention is configured to perform classifying the video by fusing a first multimodal class token, a first multimodal distillation token, a second multimodal class token, and a second multimodal distillation token, which are extracted through a first co-learning model and a second co-learning model.

The identity disinformation detection system 100 is configured to calculate the probabilities for the first multimodal class token and the first multimodal distillation token (VA Class, VA Distillation) by inputting the first multimodal class token and the first multimodal distillation token of the fused data generated through the fusion into a pre-trained classifier, respectively, calculate average of probabilities and then calculate a first probability indicating the presence of identity disinformation based on the interaction between visual information and auditory information.

In addition, the identity disinformation detection system 100 is configured to calculate probabilities (VT Class, VT Distillation) for the second multimodal class token and the second multimodal distillation token respectively, by inputting the second multimodal class token and the second multimodal distillation token of the fused data generated through the fusion, into another pre-trained classifier, respectively, and calculate average of probabilities and then calculate a first probability indicating the presence of identity disinformation based on the interaction between visual information and auditory information.

In addition, the identity disinformation detection system 100 is configured to detect whether the identity disinformation is present in video according to the average value of the first probability and the second probability. If the average value exceeds a predetermined threshold, the system is configured to detect that the video contains identity disinformation (i.e., deepfake). If the average value is below the predetermined threshold, the system is configured to determine that the video does not contain identity disinformation.

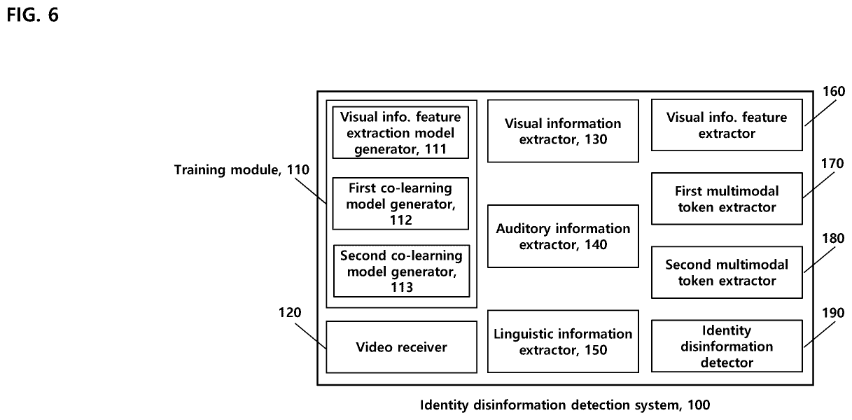

FIG. 6 is a block diagram illustrating a system for detecting zero-shot identity disinformation using multimodal interaction in video according to an embodiment of the present invention.

As shown in FIG. 6, the identity disinformation detection system 100 according to an embodiment of the present invention comprises a training module 110, a video receiver 120, a visual information extractor 130, an auditory information extractor 140, a linguistic information extractor 150, a visual information feature extractor 160, a first multimodal token extractor 170, a second multimodal token extractor 180, and an identity disinformation detector 190.

The training module 110 is configured to create a multimodal interaction learning model (an identity disinformation detection model) and comprises a visual information feature extraction model generator 111, a first co-learning model generator 112, and a second co-learning model generator 113.

The visual information feature extraction model generator 111 is configured to generate a visual information feature extraction model by training on visual information embedding sequences for training, which are created by embedding class tokens corresponding to the visual information extracted from each of a plurality of training videos, a plurality of patches of the extracted visual information, and positional information for each of the plurality of patches. The training is performed through a Vision Transformer (VT), and the process of generating the visual information feature extraction model is described with reference to FIG. 2 and FIG. 3, and thus the description is omitted herein.

The first co-learning model generator 112 is generated by training interaction between visual information and auditory information and configured to generate the first co-learning model for extracting a first multimodal class token and a first multimodal distillation token for a video.

To this end, the first co-learning model generator 112 is configured to generate a first co-learning model that outputs a first multimodal class token and a first multimodal distillation token for a video, by training on a first multimodal training input sequence, which embeds a multimodal class token and a multimodal distillation token for the visual information of the training video extracted by using the visual information feature extraction model, a plurality of patches which divide the auditory information extracted from the training video, and the positional information for each of the plurality of patches.

The first co-learning model is generated by training using a VAT (Vision-Audio Transformer), which is described with reference to FIG. 2 and FIG. 4, and thus a detailed explanation is omitted herein.

In addition, the second co-learning model generator 113 is configured to generate a second co-learning model for extracting a second multimodal class token and a second multimodal distillation token for a video by training the interaction between visual information and linguistic information.

To this end, the second co-learning model generator 113 is configured to generate a second co-learning model that outputs a second multimodal class token and a second multimodal distillation token for a video, by training on a second multimodal training input sequence, which embeds a multimodal class token and a multimodal distillation token for the visual information of the training video extracted by using the visual information feature extraction model, each of a plurality of word tokens for the linguistic information extracted from the corresponding training video, and positional information for each of the plurality of the word tokens.

The second co-learning model is generated by training using a VTT (Vision-Text Transformer), which is described with reference to FIG. 2 and FIG. 4, and thus a detailed explanation is omitted herein.

The video receiver 120 is configured to receive videos from outside of the identity disinformation detection system 100. The videos may be provided by a user terminal (not shown) connected to the identity disinformation detection system 100, or may be directly input via Web.

In other words, the identity disinformation detection system 100 may be implemented in the form of a cloud server and can receive videos from a user terminal that requests detection of identity disinformation within the videos.

The visual information extractor 130 is configured to extract visual information from the received video. The visual information may be extracted by selecting a mid frame from the entire sequence of video frames.

The auditory information extractor 140 is configured to extract auditory information corresponding to the extracted visual information. The auditory information extractor 140 is configured to extract the auditory information by converting the waveform corresponding to the visual information into MFCCs (Mel Frequency Cepstral Coefficients).

The linguistic information extractor 150 is configured to extract linguistic information corresponding to the visual information. The linguistic information extractor 150 is configured to extract by selecting linguistic information that has a similarity exceeding a predetermined threshold (e.g., 0.9) with the extracted auditory information.

The visual information feature extractor 160 is configured to divide the extracted visual information into a plurality of patches and construct a visual information embedding sequence by embedding each of the dividend patches and positional information for each of the plurality of patches, input the constructed visual information embedding sequence into the visual information feature extraction model, and then extract visual information features including a multimodal class token and a multimodal distillation token for the visual information.

The first multimodal token extractor 170 is configured to divide the extracted auditory information into a plurality of patches, and construct a first multimodal input sequence by embedding each of the plurality of dividend auditory patches, positional information for each of the plurality of patches, the multimodal class token and multimodal distillation token extracted by the visual information feature extractor 160, input the constructed first multimodal input sequence into the first co-learning model, and then extract the first multimodal class token and the first multimodal distillation token for the video.

The second multimodal token extractor 180 is configured to divide the extracted linguistic information into a plurality of word tokens, and construct a second multimodal input sequence by embedding each of a plurality of the word tokens, positional information for each of the plurality of the word tokens, the multimodal class token and multimodal distillation token extracted by the visual information feature extractor 160, input the constructed second multimodal input sequence into the second co-learning model, and then extract the second multimodal class token and the second multimodal distillation token for the video according to the interaction between the visual information and linguistic information.

The identity disinformation detector 190 is configured to generate fused data by integrating the first multimodal class token, the first multimodal distillation token, the second multimodal class token, and the second multimodal distillation token, which are extracted through the first co-learning model and the second co-learning model and detect whether the video contains identity disinformation based on the fused data.

How the identity disinformation is detected is described with reference to FIG. 5, and thus a detailed explanation is omitted herein.

Hereinafter, the results of a comparative evaluation between the present invention and prior arts are followed.

For the purpose of the comparative evaluation, the FakeAVCeleb dataset, which consists of 500 deepfaked videos, is used, and the data for training, validation, and testing are organized to ensure no overlap among them.

The AI models used for comparison with the present invention are tested using the model weights that achieve the highest validation accuracy at 100 epochs.

The evaluation metrics used were accuracy, as defined in [Equation 7], and F1-Score, as defined in [Equation 8].

$$Accuracy = ( TP + TN ) / ( TP + TN + FP + FN ) \qquad [ Equation 7 ]$$

$$F 1 - Score = ( 2 ( TP ) / ( 2 ( TP ) + FP + FN ) \qquad [ Equation 8 ]$$

Wherein, TP (True Positive) refers to true positives, TN (True Negative) to true negatives, FP (False Positive) to false positives, and FN (False Negative) to false negatives.

In a case of extracting linguistic information, real data and fake data from 495 individuals with a confidence score of 0.9 or higher are used. If a specific modality is identified as a deepfake, the corresponding label is assigned to be assumed as a deepfake (fake).

The datasets for training, validation, and testing are organized to ensure no overlap among them, allowing the detection and evaluation of zero-shot identity disinformation.

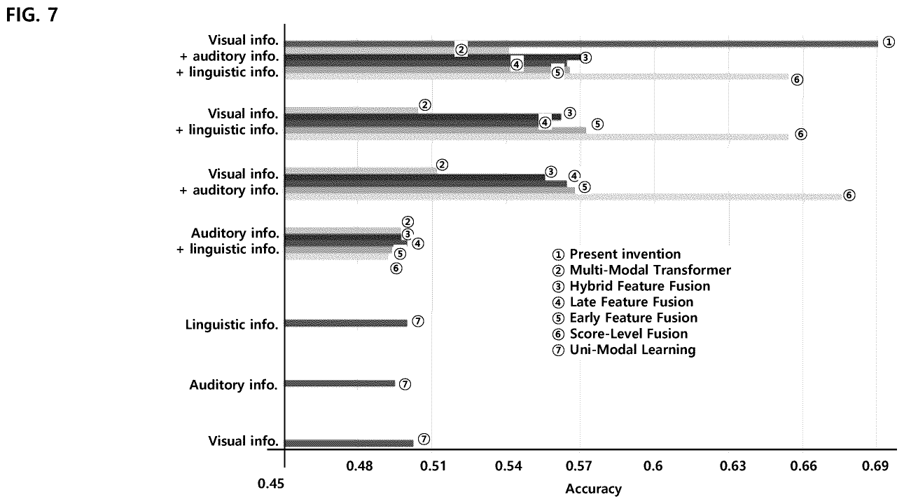

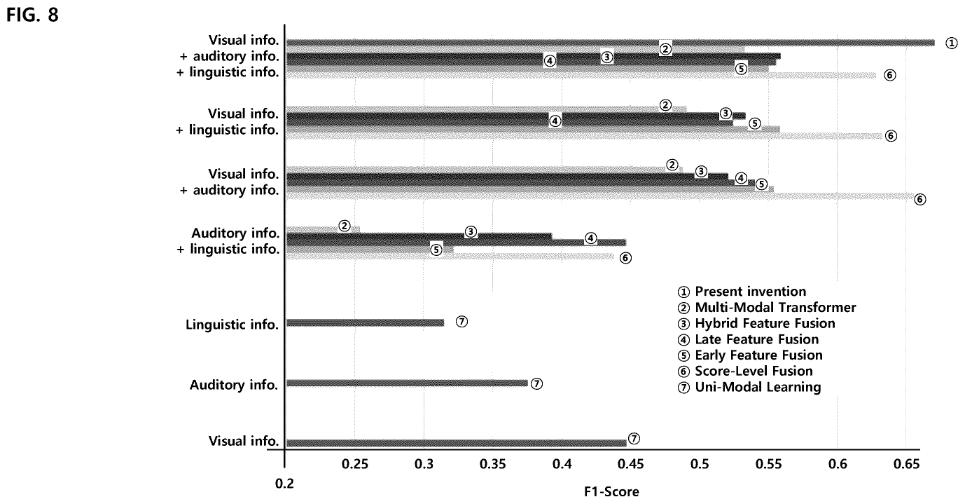

FIG. 7 is a diagram illustrating performance comparison between the present invention and prior arts through accuracy according to an embodiment of the present invention, and FIG. 8 is a diagram illustrating performance comparison between the present invention and prior arts through F1-Score according to an embodiment of the present invention.

As shown in FIG. 7, the accuracy of the present invention is 0.69, which is higher than that of other conventional methods.

It can be seen that detecting identity disinformation using two or more multimodal inputs results in higher accuracy compared to using a single-modal (Uni-Modal) approach.

Furthermore, as shown in FIG. 8, the present invention also achieves a higher F1-Score than other conventional techniques

The score-level fusion method in conventional approaches demonstrates the highest deepfake detection performance among existing techniques, as it analyzes the probability values of real and fake images separately for each modality. In contrast, the multimodal transformer shows the lowest detection performance among conventional methods, as it does not consider each modality independently.

Moreover, it can be observed that the performance of deepfake detection improves as the number of modalities increases. Ultimately, the present invention is capable of effectively detecting deepfakes by leveraging visual information, auditory information, and linguistic information altogether.

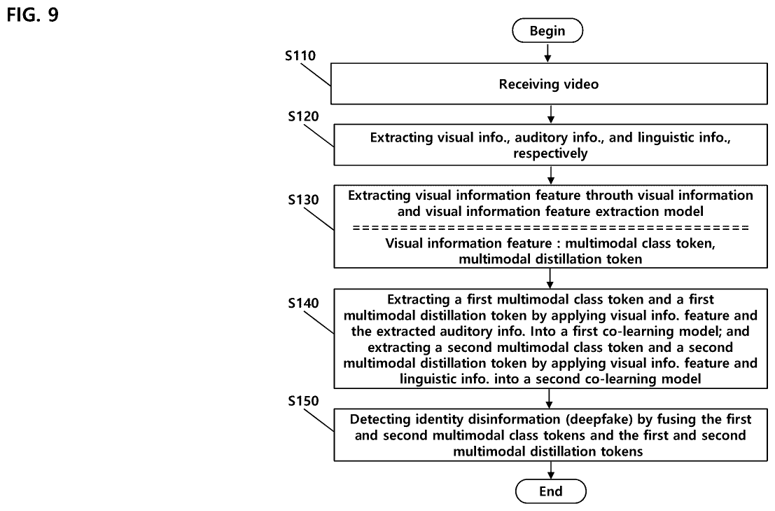

FIG. 9 is a flow chart illustrating procedures for detecting zero-shot identity disinformation using multimodal interaction in video according to an embodiment of the present invention.

As shown in FIG. 9, the procedure for detecting identity disinformation for zero-shot identities using multimodal interaction within video begins with receiving the video in the identity disinformation detection system 100.

The video may be received from a user terminal (not shown) that requests identity disinformation detection.

Next, the identity disinformation detection system 100 is configured to extract visual information from the received video, extract auditory information from the received video, and extract linguistic information, in S120.

The processes of extracting visual information, auditory information, and linguistic information are described with reference to FIG. 1 and thus the description of the processes is omitted herein.

Subsequently, the identity disinformation detection system 100 is configured to extract visual information feature, including a multimodal class token and a multimodal distillation token through the extracted visual information and visual information feature extraction model, as shown in S130.

As shown in S130, the extracting of visual information feature comprises constructing a visual information embedding sequence, by dividing the extracted video into a plurality of patches and embedding each of the plurality of the dividend patches and positional information for each of the plurality of patches, inputting the constructed visual information embedding sequence into a visual information feature extraction model, and thereby extracting the visual information feature.

The extraction of visual features using the visual information feature extraction model is described with reference to FIG. 2 and FIG. 3, and thus the detailed description is omitted herein.

Next, the identity disinformation detection system 100 is configured to extract a first multimodal class token and a first multimodal distillation token by applying extracted visual information feature and auditory information to the first joint learning model, and a second multimodal class token and a second multimodal distillation token by applying extracted visual information feature and linguistic information to the second co-learning model.

In other words, the identity disinformation detection system 100 is configured to extract the first multimodal class token and the first multimodal distillation token according to the interaction between visual information and auditory information, and the second multimodal class token and the second multimodal distillation token according to the interaction between visual information and linguistic information.

Both processes for extracting the first multimodal class token and the first multimodal distillation token, and the second multimodal class token and the second multimodal distillation token are described with reference to FIG. 2 to FIG. 4, and thus further detailed explanation is omitted herein.

Subsequently, the identity disinformation detection system 100 is configured to detect identity disinformation for received video fused with the first multimodal class token, the first multimodal distillation token, the second multimodal class token, and the second multimodal distillation token, and including for zero-shot identities, as shown in S150.

The process of detecting identity disinformation is described with reference to FIG. 5 and therefore further detailed explanation is omitted herein.

As described above, the present invention enables the detection of identity disinformation for video by learning the interactions between different modalities in the video, extracting multimodal class tokens representing whether the identity disinformation is present for the video according to the interaction and multimodal distillation tokens representing features, and fusing these tokens.

As mentioned above, the present disclosure has been explained with reference to the embodiments shown in the drawings, but this is merely illustrative embodiments, and one skilled in the art will understand that various modifications and equivalent alternative embodiments are possible. Therefore, the technical scope of the present invention should be determined by the following claims.

The reference numerals in the drawings are indicated as 100 refers to an identity disinformation detection system, 110 to a training module, 111 to a visual information feature extractor, 112 to a first co-learning model generator, 113 to a second co-learning model generator, 120 to a video receiver, 130 to a visual information extractor, 140 to a auditory information extractor, 150 to a linguistic information extractor, 160 to a visual information feature extractor, 170 to a first multimodal token extractor, 180 to a second multimodal token extractor, and 190 to an identity disinformation detector.

What is claimed is:

1. A system for detecting zero-shot identity disinformation using multimodal interaction in video, comprises:
a visual information extractor configured to extract visual information from the video;
an auditory information extractor configured to extract auditory information corresponding to the visual information extracted from the video;
a linguistic information extractor configured to extract linguistic information corresponding to the auditory information extracted from the video;
a visual information feature extractor configured to extract visual information feature using the extracted visual information;
a first multimodal token extractor configured to extract a first multimodal class token and a first multimodal distillation token of the video according to interaction between the visual information and the auditory information by applying the extracted visual information feature and the extracted auditory information to a first co-learning model;
a second multimodal token extractor configured to extract a second multimodal class token and a second multimodal distillation token of the video according to interaction between the visual information and the linguistic information by applying the extracted visual information feature and the extracted linguistic information to a second co-learning model; and
an identity disinformation detector configured to detect identity disinformation for the video by fusing the extracted first multimodal class token, the extracted first multimodal distillation token, the extracted second multimodal class token, and the extracted second multimodal distillation token,
wherein the first co-learning model is configured to be generated by training the interaction between visual information and auditory information by performing co-learning of visual information feature and auditory information of training video, and the second co-learning model is configured to be generated by training the interaction between visual information and linguistic information by performing co-learning of visual information feature and linguistic information of the training video.

2. The system of claim 1, wherein the visual information extractor is further configured to extract the visual information by extracting mid frame from entire frames of the video;
the auditory information extractor is further configured to extract the auditory information by transforming a waveform corresponding to the visual information into 2-dimensional MFCC (Mel Frequency Cepstral Coefficient); and
the linguistic information extractor is further configured to extract the linguistic information by extracting texts corresponding to the visual information and transforming each of words composing the texts into a word token.

3. The system of claim 1, wherein the visual information feature extractor is further configured to construct a visual information embedding input sequence by dividing the extracted visual information into a plurality of patches and embedding the dividend plurality of patches and positional information for each of the plurality of patches for the visual information, and
extract the visual information feature including multimodal class token and multimodal distillation token for the visual information by applying the constructed visual information embedding input sequence into a visual information feature extraction model.

4. The system of claim 3, wherein the visual information feature extraction model is configured to be generated by training a visual information embedding input sequence for training, which embeds multimodal class token for the visual information extracted from each of a plurality of training videos, a plurality of patches for the visual information, and positional information for each of the plurality of patches,
output multimodal class token and multimodal distillation token indicating class for the visual information, when a visual information embedding input sequence for a real video is input, and
output feature tokens for each of the plurality of patches of the inputted a visual information embedding input sequence, and output the multimodal class token by concatenating the feature tokens.

5. The system of claim 1, wherein the first multimodal token extractor is further configured to construct a first multimodal input sequence by dividing the extracted auditory information into a plurality of patches, and embedding each of the plurality of the patches, positional information of each of the plurality of the patches, and the extracted visual information feature, and
extract the first multimodal class token and the first multimodal distillation token by applying the constructed first multimodal input sequence to the first co-learning model,
wherein the first co-learning model is configured to be generated by training interaction between visual information and auditory information by cooperatively training visual information and auditory information of the video through each of the first multimodal input sequences constructed for each of the plurality of training videos.

6. The system of claim 1, wherein the second multimodal token extractor is further configured to construct a second multimodal input sequence by embedding a word token for each word composed of the extracted linguistic information, positional information of each word token, and the extracted visual information feature, and
extract the second multimodal class token and the second multimodal distillation token by applying the constructed second multimodal input sequence to the second co-learning model,
wherein the second co-learning model is configured to be generated by training interaction between visual information and linguistic information by cooperatively training visual information and linguistic information of the video through each of the second multimodal input sequences constructed for each of the plurality of training videos.

7. The system of claim 1, wherein the identity disinformation detector is further configured to detect the identity disinformation by fusing the extracted first multimodal class token, the extracted first multimodal distillation token, the extracted second multimodal class token, and the extracted second multimodal distillation token, and whether the video contains identity disinformation.

8. A method for detecting zero-shot identity disinformation using multimodal interaction in video comprises:
extracting visual information from the video;
extracting auditory information corresponding to the visual information extracted from the video;
extracting linguistic information corresponding to the auditory information extracted from the video;
extracting visual information feature using the extracted visual information;
extracting a first multimodal class token and a first multimodal distillation token of the video according to interaction between the visual information and the auditory information by applying the extracted visual information feature and the extracted auditory information to a first co-learning model;
extracting a second multimodal class token and a second multimodal distillation token of the video according to interaction between the visual information and the linguistic information by applying the extracted visual information feature and the extracted linguistic information to a second co-learning model; and
detecting identity disinformation for the video by fusing the extracted first multimodal class token, the extracted first multimodal distillation token, the extracted second multimodal class token, and the extracted second multimodal distillation token,
wherein the first co-learning model is configured to be generated by training the interaction between visual information and auditory information by performing co-learning of visual information feature and auditory information of training video, and the second co-learning model is configured to be generated by training the interaction between visual information and linguistic information by performing co-learning of visual information feature and linguistic information of the training video.

9. The method of claim 8, wherein the extracting of the visual information feature further comprises:
constructing a visual information embedding input sequence by dividing the extracted visual information into a plurality of patches and embedding the dividend plurality of patches and positional information for each of the plurality of patches for the visual information, and
extracting the visual information feature including multimodal class token and multimodal distillation token for the visual information by applying the constructed visual information embedding input sequence into a visual information feature extraction model,
wherein the visual information feature extraction model is configured to be generated by training a visual information embedding input sequence for training, which embeds multimodal class token for the visual information extracted from each of a plurality of training videos, a plurality of patches for the visual information, and positional information for each of the plurality of patches,
output multimodal class token and multimodal distillation token indicating class for the visual information, when a visual information embedding input sequence for a real video is input, and
output feature tokens for each of the plurality of patches of the input visual information embedding input sequence and output the multimodal class token by concatenating the feature tokens.

10. The method of claim 8, wherein the extracting of the first multimodal token further comprises: constructing a first multimodal input sequence by dividing the extracted auditory information into a plurality of patches, and embedding each of the plurality of the patches, positional information of each of the plurality of the patches, and the extracted visual information feature, and
extracting the first multimodal class token and the first multimodal distillation token by applying the constructed first multimodal input sequence to the first co-learning model,
wherein the extracting of the second multimodal token further comprises:
constructing a second multimodal input sequence by embedding a word token for each word composed of the extracted linguistic information, positional information of each word token, and the extracted visual information feature, and
extracting the second multimodal class token and the second multimodal distillation token by applying the constructed second multimodal input sequence to the second co-learning model,
the detecting of identity disinformation comprises:
detecting the identity disinformation by classifying whether the video contains identity disinformation by fusing the extracted first multimodal class token, the extracted first multimodal distillation token, the extracted second multimodal class token, and the extracted second multimodal distillation token.
